(19) United States
(12) Patent Application Publication
(10) Pub. No.: US 2021/0258237 A1
(43) Pub. Date: Aug. 19, 2021

(54) METHOD AND DEVICE FOR DETERMINING A FIRST PARAMETER CHARACTERIZING A PACKET ERROR RATE

(71) Applicant: Robert Bosch GmbH, Stuttgart (DE)

(72) Inventors: Michael Gabb, Gaeufelden (DE); Soheil Gherekhloo, Lauffen Am Neckar (DE)

(21) Appl. No.: 17/179,377

(22) Filed: Feb. 18, 2021

(30) Foreign Application Priority Data
Feb. 19, 2020 (DE) 102020202133.3

(51) Int. Cl. H04L 12/26; H04W 24/08; H04W 4/40

(52) U.S. Cl. CPC H04L 43/0823; H04W 4/40; H04W 24/08

(57) ABSTRACT

Method for determining a first parameter characterizing a packet error rate of a wireless packet-based data transmission in a radiocommunication system, comprising the following steps: determining a second parameter characterizing a bit error rate, BER, based on at least one operating parameter of the radiocommunication system, determining the first parameter based on the second parameter and a third parameter which characterizes a number of bits per data packet.

### BACKGROUND OF THE INVENTION

The disclosure relates to a method for determining a first parameter characterizing a packet error rate of a wireless packet-based data transmission in a radiocommunication system.

The disclosure further relates to a device for determining a first parameter characterizing a packet error rate of a wireless packet-based data transmission in a radiocommunication system.

### SUMMARY OF THE INVENTION

Preferred embodiments relate to a method for determining a first parameter characterizing a packet error rate of a wireless packet-based data transmission in a radiocommunication system, having the following steps: determining a second parameter characterizing a bit error rate, BER, based on at least one operating parameter of the radiocommunication system, determining the first parameter based on the second parameter and a third parameter which characterizes a number of bits per data packet. This advantageously enables an efficient determination of the first parameter, in particular with no time delay, compared e.g. with conventional approaches which are based on the formation of statistics relating to previously transmitted data packets.

In further preferred methods, it is provided that the at least one operating parameter of the radiocommunication system has at least one of the following elements: a) signal-to-noise ratio, b) modulation parameter, c) modulation method, d) modulation and coding scheme, MCS, e) current speed of a transmitter and/or receiver, f) channel model, g) coding scheme, h) coherence time of a (radio) channel, i) bandwidth of a or the channel.

In further preferred methods, it is provided that the third parameter characterizes a number of bits per data packet at the application layer (Layer 7) of the ISO/OSI reference model.

In further preferred methods, it is provided that the first parameter characterizes an instantaneous and/or expected packet error rate.

In further preferred methods, it is provided that the first parameter is determined independently from a transmission of one or more data packets, in particular without a data packet being transmitted.

In further preferred methods, it is provided that the method further comprises: determining a compound probability from a consecutive loss of a number K of data packets in succession, and, optionally, determining the first parameter depending on the compound probability. According to further preferred embodiments, this aspect can be implemented alternatively or additionally to at least one of the embodiments described above.

Further preferred embodiments relate to a device to carry out the method according to the embodiments.

In further preferred embodiments, it is provided that the device has at least one of the following elements: a computing device (“computer”), b) a storage device, c) a transmit device, in particular for transmitting at least one data packet, d) a receive device, in particular for receiving at least one data packet.

Further preferred embodiments relate to a computer-readable storage medium, comprising commands, particularly in the form of a computer program, which, when executed by a computer, cause said computer to carry out the method according to the embodiments.

Further preferred embodiments relate to a computer program, comprising commands which, when the program is executed by a computer, cause said computer to carry out the method according to the embodiments.

Further preferred embodiments relate to a data carrier signal which transmits and/or characterizes the computer program according to the embodiments.

Further preferred embodiments relate to a use of the method according to the embodiments and/or the device according to the embodiments and/or the computer program according to the embodiments for at least one of the following elements: a) vehicle-to-vehicle, V2V, communication, b) vehicle-to-road, V2R, communication, c) vehicle-to-infrastructure, V2I, communication, d) vehicle-to-network, V2N, communication, e) vehicle-to-pedestrian, V2P, communication, f) V2X (vehicle-to-everything) communication, g) instantaneous determination of a packet error rate, h) passive determination of a or the packet error rate, i) use of the first parameter for functional safety aspects and/or methods, j) influencing the data transmission in the radiocommunication system, in particular depending on the first parameter.

### BRIEF DESCRIPTION OF THE DRAWINGS

Further features, possible applications and advantages of the invention are set out in the following description of example embodiments of the invention which are shown in the figures of the drawing. All features described or illustrated, either individually or in any combination, form the subject-matter of the invention, irrespective of their summarization in the claims or their back-reference, and irrespective of their wording or representation in the description or in the drawing.

In the drawing:

FIG. 1 shows schematically a simplified flow diagram of a method according to preferred embodiments,

FIG. 2 shows schematically a simplified flow diagram according to further preferred embodiments,

FIG. 3 shows schematically a simplified block diagram of a device according to further preferred embodiments, and

FIG. 4 shows schematically a block diagram according to further preferred embodiments.

### DETAILED DESCRIPTION

FIG. 4 shows schematically a radiocommunication system 10 according to preferred embodiments, having a transmitter Tx and a receiver Rx. The transmitter Tx has a channel coder 11 which, from input data, e.g. a bit stream, forms a coded signal 11a which is modulated by a modulator 12, e.g. an OFDM (orthogonal frequency division multiplexing) modulator, as a result of which an (OFDM-) modulated signal 12a is obtained. The signal 12a is transmittable via a channel 13, in particular a radiocommunication channel, e.g. in the form of data packets, and can be received e.g. as a signal 14 by a receiver Rx. Block 15 performs a demodulation, in particular an OFDM demodulation, and outputs a bit sequence 16 characterizing the demodulated signal to a channel decoder 17. The channel decoder 17 determines a (channel-) decoded signal 17a therefrom. Errors in the radio transmission via the channel 13 can be characterized in further embodiments e.g. by means of a bit error rate (BER).

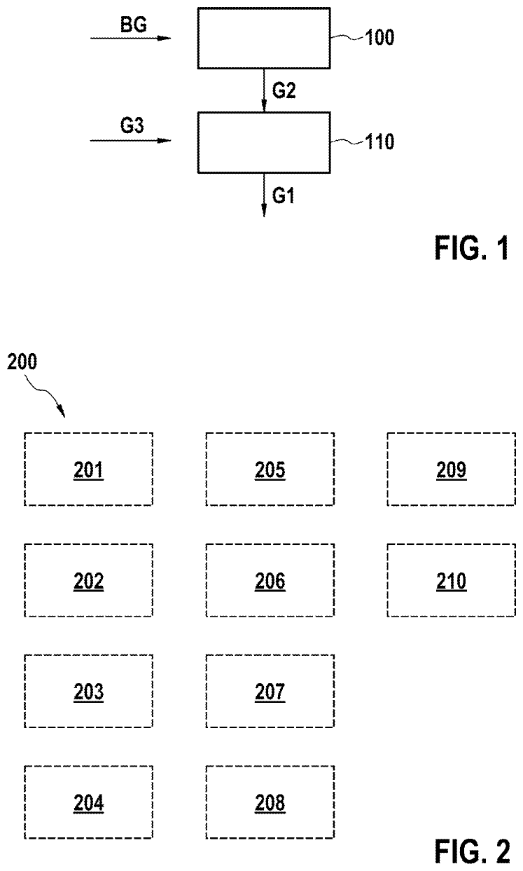

Further preferred embodiments relate to a method for determining a first parameter characterizing a packet error rate (PER) of a wireless packet-based data transmission, as can be performed e.g. in the radiocommunication system 10 according to FIG. 4, comprising the following steps, cf. FIG. 1: determining 100 a second parameter G2 characterizing a bit error rate, BER, based on at least one operating parameter BG of the radiocommunication system 10 (FIG. 4), determining 110 (FIG. 1) the first parameter G1 based on the second parameter G2 and a third parameter G3 which characterizes a number of bits per data packet, for example determining the first parameter G1 as a product of the second parameter G2 and the third parameter G3. This advantageously enables an efficient determination of the first parameter G1, in particular with no time delay, compared e.g. with conventional approaches which are based on the formation of statistics relating to previously transmitted data packets.

In further preferred methods, it is provided that the at least one operating parameter BG of the radiocommunication system (FIG. 4) has one of the following elements: a) signal-to-noise ratio (SNR), b) modulation parameter, c) modulation method, d) modulation and coding scheme, (MCS), e) current speed of a transmitter Tx (FIG. 4) and/or receiver Rx, f) channel model, g) coding scheme, h) coherence time of a (radio) channel, i) bandwidth of a or the channel.

In further preferred methods, it is provided that the third parameter G3 characterizes a number of bits per data packet at the application layer (Layer 7) of the ISO/OSI reference model.

In further preferred methods, it is provided that the first parameter G1 characterizes an instantaneous and/or expected packet error rate.

In further preferred methods, it is provided that the first parameter G1 is determined cf. step 110 according to FIG. 1, independently from a transmission of one or more data packets, in particular without a data packet being transmitted.

In further preferred methods, it is provided that the method further comprises: determining (not shown) a compound probability from a consecutive loss of a number K of data packets in succession, and, optionally, determining the first parameter G1 depending on the compound probability. According to further preferred example embodiments, these two steps of determining can be carried out alternatively or additionally to the sequence e.g. according to FIG. 1.

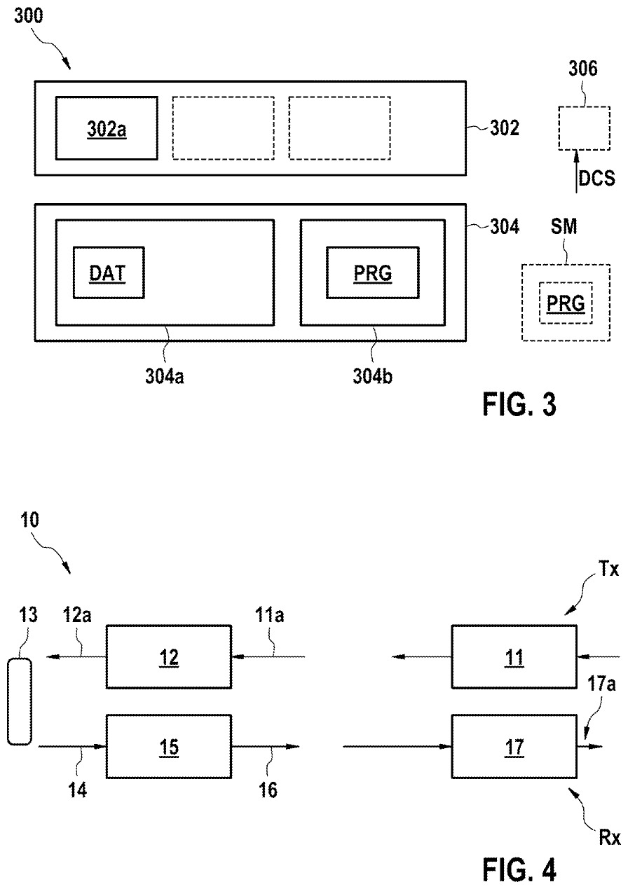

Further preferred embodiments relate to a use 200, cf. FIG. 2, of the method according to the embodiments and/or a device 300 (see below, FIG. 3) according to the embodiments and/or a computer program PRG according to the embodiments for at least one of the following elements: a) vehicle-to-vehicle, V2V, communication 201, b) vehicle-to-road, V2R, communication 202, c) vehicle-to-infrastructure, V2I, communication 203, d) vehicle-to-network, V2N, communication 204, e) vehicle-to-pedestrian, V2P, communication 205, f) V2X communication 206, g) instantaneous determination 207 of a packet error rate, h) passive determination 208 of a or the packet error rate (i.e. without transmission and/or reception of data packets), i) use 209 of the first parameter G1 for functional safety aspects and/or methods, j) influencing 210 the data transmission in the radiocommunication system 10 (FIG. 4), in particular depending on the first parameter G1.

Further preferred embodiments, cf. FIG. 3, relate to a device 300 to carry out the method according to the embodiments.

In further preferred embodiments, it is provided that the device 300 has at least one of the following elements: a computing device 302 having at least one computing core 302a, b) a storage device 304, c) a transmit device, in particular for transmitting at least one data packet, d) a receive device, in particular for receiving at least one data packet. The optional transmit device and the optional receive device are combined here into an optional transceiver 306. In further preferred embodiments, the transceiver 306 can have e.g. at least one component of the radiocommunication system 10 (FIG. 4).

Further preferred embodiments relate to a computer-readable storage medium SM (FIG. 3), comprising commands, particularly in the form of a computer program PRG, which, when executed by a computer 302, cause said computer to carry out the method according to the embodiments.

Further preferred embodiments relate to a computer program PRG, comprising commands which, when the program PRG is executed by a computer 302, cause said computer to carry out the method according to the embodiments. The computer program PRG can e.g. also be stored at least temporarily in the storage device 304, in particular in a non-volatile memory 304b, while e.g. data DAT are storable at least temporarily in a working memory (e.g. RAM) 302a. According to further preferred embodiments, the data DAT can have or characterize e.g. the second parameter G2 and/or the first parameter GI and/or the operating parameter(s) BG and/or the third parameter G3.

Further preferred embodiments relate to a data carrier signal DCS which transmits and/or characterizes the computer program PRG according to the embodiments.

In further preferred embodiments, the SNR can be determined, in particular estimated, e.g. in the receiver Rx (FIG. 4), wherein, according to further preferred embodiments, it is usable e.g. for decoding received data packets.

1. A method for determining a first parameter (G1) characterizing a packet error rate, PER, of a wireless packet-based data transmission in a radiocommunication system (10), comprising the following steps: determining (100) a second parameter (G2) characterizing a bit error rate, BER, based on at least one operating parameter (BG) of the radiocommunication system (10), determining (110) the first parameter (G1) based on the second parameter (G2) and a third parameter (G3) which characterizes a number of bits per data packet.

2. The method according to claim 1, wherein the at least one operating parameter (BG) of the radiocommunication system (10) has at least one of the following elements: a) signal-to-noise ratio, SNR, b) modulation parameter, c) modulation method, d) modulation and coding scheme, MCS, e) current speed of a transmitter (Tx) and/or receiver (Rx), f) channel model, g) coding scheme, h) coherence time of a (radio) channel, i) bandwidth of a or the channel.

3. The method according to claim 1, wherein the third parameter (G3) characterizes a number of bits per data packet at an application layer.

4. The method according to claim 1, wherein the first parameter (G1) characterizes an or the instantaneous and/or expected packet error rate.

5. The method according to claim 1, wherein the first parameter (G1) is determined independently from a transmission of one or more data packets.

6. The method according to claim 1, further comprising: determining a compound probability from a consecutive loss of a number K of data packets in succession, and, optionally, determining the first parameter (G1) depending on the compound probability.

7. A device (300) for determining a first parameter (G1) characterizing a packet error rate, PER, of a wireless packet-based data transmission in a radiocommunication system (10), and configured to
determine (100) a second parameter (G2) characterizing a bit error rate, BER, based on at least one operating parameter (BG) of the radiocommunication system (10), and
determine (110) the first parameter (G1) based on the second parameter (G2) and a third parameter (G3) which characterizes a number of bits per data packet.

8. The device (300) according to claim 7, having at least one of the following elements: a computing device (302), b) a storage device (304), c) a transmit device (306), in particular for transmitting at least one data packet, d) a receive device (306), in particular for receiving at least one data packet.

9. A non-transitory, computer-readable storage medium (SM) containing commands (PRG) which, when executed by a computer (302), cause said computer to determine a first parameter (G1) characterizing a packet error rate, PER, of a wireless packet-based data transmission in a radiocommunication system (10), by
determining (100) a second parameter (G2) characterizing a bit error rate, BER, based on at least one operating parameter (BG) of the radiocommunication system (10), and
determining (110) the first parameter (G1) based on the second parameter (G2) and a third parameter (G3) which characterizes a number of bits per data packet

10. The method according to claim 1 wherein the radiocommunication systems includes at least one of the following elements: a) vehicle-to-vehicle, V2V, communication (201), b) vehicle-to-road, V2R, communication (202), c) vehicle-to-infrastructure, V2I, communication (203), d) vehicle-to-network, V2N, communication (204), e) vehicle-to-pedestrian, V2P, communication (205), and f) V2X (vehicle-to-everything) communication (206).
